(19) United States
(12) Patent Application Publication
(10) Pub. No.: US 2026/0243126 A1
(43) Pub. Date: Aug. 20, 2026

(54) REFRIGERATOR

(71) Applicant: SAMSUNG ELECTRONICS CO., LTD., Suwon-si (KR)

(72) Inventors: Chunseong KIM, Suwon-si (KR); Taegyu KIM, Suwon-si (KR); Jongsoo HONG, Suwon-si (KR); Jihyun RYU, Suwon-si (KR); Taegyoon NOH, Suwon-si (KR); Yongchan KWON, Suwon-si (KR)

(73) Assignee: SAMSUNG ELECTRONICS CO., LTD., Suwon-si (KR)

(21) Appl. No.: 19/443,763

(22) Filed: Jan. 8, 2026

Related U.S. Application Data
(63) Continuation of application No. PCT/KR2025/021550, filed on Dec. 12, 2025.

(30) Foreign Application Priority Data
Feb. 14, 2025 (KR) 10-2025-0019117

(51) Int. Cl. E05F 15/73; F25D 23/02

(52) U.S. Cl. CPC E05F 15/73; F25D 23/028; E05Y 2900/31; F25D 2700/04

(57) ABSTRACT

A refrigerator including a main body forming a storage space; a first door including a door inner space, the first door being configured to open and close the storage space; a second door configured to be rotatable to open and close the door inner space; a door driving module configured to rotate at least one of the first door or the second door; an electric latch configured to engage the first door and the second door; at least one sensor device; and at least one processor configured to control the at least one sensor device to sense a motion of a user, and, based on the sensed motion of the user in a state in which the first door and the second door are closed, control an operation of opening the first door, or control an operation of opening the second door.

### CROSS-REFERENCE TO RELATED APPLICATIONS

This application is a by-pass continuation application of International Application No. PCT/KR 2025/021550, filed on Dec. 12, 2025, which is based on and claims priority to Korean Patent Application No. 10-2025-0019117, filed on Feb. 14, 2025, in the Korean Intellectual Property Office, the disclosures of which are incorporated by reference herein in their entireties.

### TECHNICAL FIELD

Various embodiments of the disclosure relate to a refrigerator.

### BACKGROUND ART

A refrigerator is a device that stores objects such as food in a fresh state using a refrigeration cycle, and may include a freezing chamber that stores objects in a sub-zero temperature state, and a refrigerating chamber that stores objects in an above-freezing temperature state.

With the recent spread of smart homes and the development of IoT technology, refrigerators may perform various innovative functions such as voice control, remote control through a smartphone app, and food management using internal cameras.

The refrigerator may include at least one door according to the number or structure of storage compartments. The doors of the refrigerator may be used to put objects in the storage compartment or take them out. The doors of the refrigerator are closed to prevent leakage of cold air out of the storage compartment, keeping the temperature inside the storage compartment constant.

The opening of the door of the refrigerator is performed by the user's separate manipulation based on a physical contact. There are smart refrigerators capable of automatic door opening based on the user's intention without physical contact.

The information may be provided as related art for the purpose of helping understanding of the disclosure. No claim or determination is made as to whether any of the foregoing is applicable as background art in relation to the disclosure.

### DISCLOSURE OF INVENTION

### Solution to Problems

Aspects of embodiments of the disclosure will be set forth in part in the description which follows and, in part, will be apparent from the description, or may be learned by practice of the presented embodiments.

According to an embodiment of the disclosure, a refrigerator including a main body forming a storage space; a first door including a door inner space, the first door being configured to open and close the storage space; a second door configured to be rotatable relative to the first door to open and close the door inner space; a door driving module configured to rotate at least one of the first door or the second door; an electric latch configured to engage the first door and the second door; at least one sensor device; and at least one processor configured to control the at least one sensor device to sense a motion of a user, and, based on the sensed motion of the user in a state in which the first door and the second door are closed, control an operation of opening the first door, or control an operation of opening the second door.

According to an embodiment of the disclosure, the at least one processor may be configured to, while controlling the operation of opening the first door, controlling the door driving module to open the first door, and, while controlling the operation of opening the second door, controlling an electrical signal to be transferred to the electric latch to release the engagement between the first door and the second door.

According to an embodiment of the disclosure, the at least one sensor device may include a touch sensor, and a distance sensor to detect a distance between the first door and the second door. The at least one processor may be configured to control the operation of opening the first door in response to a touch being sensed by the touch sensor, and control the operation of opening the second door in response to a door push being sensed by the distance sensor.

According to an embodiment of the disclosure, the second door may include a gasket. The distance sensor may be disposed outside the gasket on the first door.

According to an embodiment of the disclosure, the at least one processor may be configured to control a determination of a push of the second door according to a change in a distance value sensed by the distance sensor as the gasket is compressed by movement of the second door.

According to an embodiment of the disclosure, the touch sensor may be disposed at a lower portion of the first door or a lower portion of the second door.

According to an embodiment of the disclosure, the at least one sensor device may include a touch sensor. The at least one processor may be configured to control one of the operation of opening the first door or the operation of opening the second door based on a number of touches sensed using the touch sensor.

According to an embodiment of the disclosure, the at least one processor may be configured to control the operation of opening the first door in response to one touch being sensed by the touch sensor, and control the operation of opening the second door in response to multiple touches being sensed by the touch sensor.

According to an embodiment of the disclosure, the touch sensor may be disposed at a lower portion of the first door or a lower portion of the second door.

According to an embodiment of the disclosure, the at least one sensor device may include a distance sensor to detect a distance between the first door and the second door. The at least one processor may be configured to control one of the operation of opening the first door or the operation of opening the second door based on a time during which a pushed state of a door sensed by the distance sensor is maintained.

According to an embodiment of the disclosure, the second door may include a gasket. The distance sensor may be disposed outside the gasket on the first door.

According to an embodiment of the disclosure, the at least one processor may be configured to control a determination of a push of the first door or the second door according to a change in a distance value sensed by the distance sensor as the gasket is compressed, and, based on a duration time of a pushed state of the first door or the second door, control the operation of opening the first door in response to the duration time being less than a threshold time, and control the operation of opening the second door in response to the duration time being greater than the threshold time.

According to an embodiment of the disclosure, the door driving module may include a first motor, and a pusher configured to receive power from the first motor and press the first door or the second door.

According to an embodiment of the disclosure, the door driving module may include a second motor, and a closing arm coupled to the first door and configured to receive power from the second motor to close the first door.

According to an embodiment of the disclosure, the pusher may be configured to press the second door. During the operation of opening the first door, the pusher may rotate the first door and the second door by pressing the second door in a state in which the first door is engaged with the second door. During the operation of opening the second door, the pusher may rotate the second door by pressing the second door in a state in which the first door is disengaged with the second door.

According to an embodiment of the disclosure, the refrigerator may further include an open/close sensor to sense whether a door is open.

According to an embodiment of the disclosure, the open/close sensor may include one of a magnetic sensor, a position sensor, or a reed switch.

According to an embodiment of the disclosure, in a state in which one of the first door or the second door is open, the at least one processor may be configured to control a closing operation of the open one of the first door or the second door in response to the at least one sensor device sensing a predetermined motion of the user.

According to an embodiment of the disclosure, in response to one of the first door or the second door being open for more than a set reference time, the at least one processor may be configured to control a closing operation of the one of the first door or the second door that is open.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF DRAWINGS

These and/or other aspects of the disclosure will become apparent and more readily appreciated from the following description of embodiments, taken in conjunction with the accompanying drawings listed below.

FIG. 1 is a perspective view illustrating an outer appearance of a refrigerator according to an embodiment of the disclosure.

FIG. 2 is a perspective view illustrating an opened outer door of a refrigerator according to an embodiment of the disclosure.

FIG. 3 is a perspective view illustrating an opened inner door of a refrigerator according to an embodiment of the disclosure.

FIG. 4 is a control block diagram illustrating a refrigerator according to an embodiment of the disclosure.

FIG. 5 is a view illustrating an outer door and an inner door of a refrigerator according to an embodiment of the disclosure.

FIGS. 6A and 6B are views illustrating an internal structure of a door driving device of a refrigerator according to an embodiment of the disclosure.

FIG. 7 is a view illustrating an outer door and an inner door of a refrigerator separated in an unfolded state according to an embodiment of the disclosure.

FIG. 8 is a cross-sectional view schematically illustrating an operation of detecting a push using a distance sensor of a refrigerator according to an embodiment of the disclosure.

FIG. 9 is a perspective view illustrating a door of a refrigerator viewed from below according to an embodiment of the disclosure.

FIG. 10 is a schematic view illustrating a first open mode and a second open mode of a refrigerator according to an embodiment of the disclosure.

FIG. 11 is a flowchart illustrating an automatic door opening and closing operation using a touch sensor and a distance sensor according to an embodiment of the disclosure.

FIG. 12 is a flowchart illustrating an automatic door opening and closing operation using a touch sensor according to an embodiment of the disclosure.

FIG. 13 is a flowchart illustrating an automatic door opening and closing operation using a distance sensor according to an embodiment of the disclosure.

FIG. 14 is a flowchart illustrating an automatic door closing operation of a refrigerator according to an embodiment of the disclosure.

Reference may be made to the accompanying drawings in the following description, and specific examples that may be practiced are shown as examples within the drawings. Other examples may be utilized and structural changes may be made without departing from the scope of the various examples.

### MODE FOR THE INVENTION

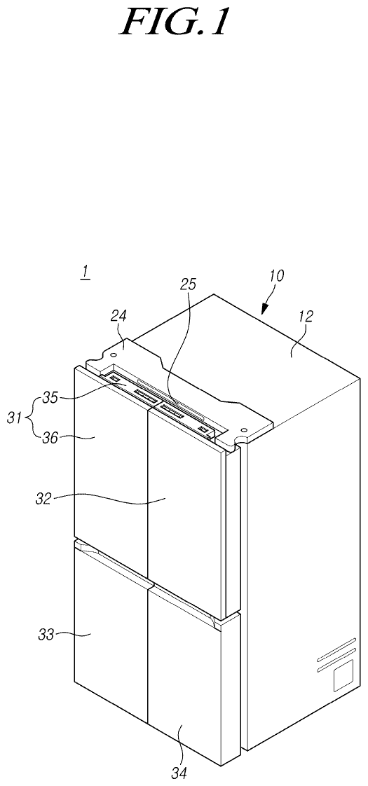

Various embodiments of the disclosure are merely exemplified herein with reference to FIGS. 1 to 14, to describe the principle of the disclosure, and should not be interpreted as limiting the scope of the disclosure. Those skilled in the art will understand that the principle of the disclosure may be implemented in any appropriately disposed system or device.

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

The term “and/or” may denote a combination(s) of a plurality of related components as listed or any of the components.

As used herein, such terms as “1st” and “2nd,” or “first” and “second” may be used to simply distinguish a corresponding component from another, and does not limit the components in other aspect (e.g., importance or order).

As used herein, the terms ‘front surface,’ ‘rear surface,’ ‘upper surface,’ ‘side surface,’ ‘left side,’ ‘right side,’ ‘upper portion,’ and ‘lower portion’ are defined with respect to the drawings, and the shape and position of each component are not limited by the terms.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

The refrigerator according to an embodiment may include a main body.

The “main body” may include an inner case, an outer case disposed outside the inner case, and an insulator provided between the inner case and the outer case.

The “inner case” may include at least one of a case, a plate, a panel, or a liner forming a storage compartment. The inner case may be formed as a single body or may be formed by assembling a plurality of plates. The “outer case” may form the outer appearance of the main body and may be coupled to an outer side of the inner case so that the insulator is disposed between the inner case and the outer case.

The “insulator” may insulate the inside of the storage compartment and the outside of the storage compartment so that the temperature inside the storage compartment is maintained at a set appropriate temperature without being affected by the environment outside the storage compartment. According to an embodiment, the insulator may include a foam insulator. The foam insulator may be formed by injecting and foaming a urethane foam formed by mixing polyurethane and a foaming agent between the inner case and the outer case.

According to an embodiment, the insulator may further include a vacuum insulator in addition to the foam insulator, or the insulator may be composed of only a vacuum insulator instead of the foam insulator. The vacuum insulator may include a core material and an outer cover material that accommodates the core material and seals the inside at a pressure close to vacuum or vacuum. However, the insulator is not limited to the foam insulator or the vacuum insulator, and may include various materials that may be used for insulation.

The “storage compartment” may include a space limited by the inner case. The storage compartment may further include an inner case that limits a space corresponding to the storage compartment. Various items such as food, medicine, cosmetics, etc. may be stored in the storage compartment, and the storage compartment may be formed so that at least one side thereof is opened to take in and out the items.

The refrigerator may include one or more storage compartments. When two or more storage compartments are formed in the refrigerator, each storage compartment may have a different use and may be maintained at a different temperature. To that end, each storage compartment may be partitioned from each other by a partition wall including an insulator.

The storage compartment may be provided to be maintained in an appropriate temperature range according to the use, and may include a “refrigerating compartment”, a “freezing compartment”, or an “adjustable-temperature compartment” divided by the use and/or temperature range thereof. The refrigerating compartment may be maintained at a temperature suitable for refrigerating and storing items, and the freezing compartment may be maintained at a temperature suitable for freezing and storing items. The term “refrigerating” may mean cooling the item to the extent that the item is not frozen, and for example, the refrigerating compartment may be maintained in the range of 0 degrees Celsius to 7 degrees Celsius. The term “freezing” may mean cooling the item to freeze or remain frozen, and for example, the freezing compartment may be maintained in the range of minus 20 degrees Celsius to minus 1 degree Celsius. The adjustable-temperature compartment may be used as any one of the refrigerating compartment or the freezing compartment regardless of the user's selection.

The storage compartment may be referred to as a “vegetable compartment”, a “fresh compartment”, a “cooling compartment”, an “ice-making compartment”, and the like, in addition to the names “refrigerating compartment”, “freezing compartment”, and “adjustable-temperature compartment”, and the terms “refrigerating compartment”, “freezing compartment”, and “adjustable-temperature compartment” used below should be understood to collectively mean storage compartments having their respective corresponding uses and temperature ranges.

According to an embodiment, the refrigerator may include at least one door configured to open and close one open side of the storage compartment. The door may be provided to open and close each of one or more storage compartments, or one door may be provided to open and close a plurality of storage compartments. The door may be rotatably or slidably installed on the front surface of the main body.

The “door” may be configured to seal the storage compartment when the door is closed. Like the main body, the door may include an insulator to insulate the storage compartment when the door is closed.

According to an embodiment, the door may include a door outer plate forming a front surface of the door, a door inner plate forming a rear surface of the door and facing the storage compartment, an upper cap, a lower cap, and a door insulator provided thereinside.

A gasket may be provided on the edge of the door inner plate to seal the storage compartment by being in close contact with the front surface of the main body when the door is closed. The door inner plate may include a dyke protruding rearward to mount a door basket capable of storing an object.

According to an embodiment, the door may include a door body and a front panel detachably coupled to a front side of the door body and forming a front surface of the door. The door body may include a door outer plate forming a front surface of the door body, a door inner plate forming a rear surface of the door body and facing the storage compartment, an upper cap, a lower cap, and a door insulator provided thereinside.

The refrigerator may be classified into a French door type, a side-by-side type, a bottom mounted freezer (BMF), a top mounted freezer (TMF), or a one-door refrigerator according to the arrangement of the door and the storage compartment.

According to an embodiment, the refrigerator may include a cold air supply device configured to supply cold air to the storage compartment.

The “cold air supply device” may include a machine, an instrument, an electronic device, and/or a system combining the machine, the instrument, and the electronic device capable of generating cold air and guiding the cold air to cool the storage compartment.

According to an embodiment, the cold air supply device may generate cold air through a refrigerating cycle including processes of compressing, condensing, expanding, and evaporating the refrigerant. To that end, the cold air supply device may include a refrigerating cycle device having a compressor, a condenser, an expansion device, and an evaporator capable of driving the refrigerating cycle. According to an embodiment, the cold air supply device may include a semiconductor such as a thermoelectric element. The thermoelectric element may cool the storage compartment by heating and cooling through the Peltier effect.

According to an embodiment, the refrigerator may include a machine room in which at least some components belonging to the cold air supply device are arranged.

The “machine room” may be provided to be partitioned and insulated from the storage compartment to prevent heat generated from components disposed in the machine room from being transferred to the storage compartment. The inside of the machine room may be configured to communicate with the outside of the main body to dissipate heat from components disposed inside the machine room.

According to an embodiment, the refrigerator may include a dispenser provided on the door to provide water and/or ice. The dispenser may be provided on the door to be accessed by the user without opening the door.

According to an embodiment, the refrigerator may include an ice maker provided to generate ice. The ice maker may include an ice-making tray storing water, an ice maker separating ice from the ice-making tray, and an ice bucket storing ice generated in the ice-making tray.

According to an embodiment, the refrigerator may include a controller for controlling the refrigerator.

The “controller” may include a memory storing or recording a program and/or data for controlling the refrigerator, and a processor outputting a control signal for controlling the cold air supply device according to the program and/or data stored in the memory.

The memory stores or records various information, data, instructions, programs, etc. necessary for the operation of the refrigerator. The memory may store temporary data generated while generating a control signal for controlling components included in the refrigerator. The memory may include at least one of a volatile memory and a non-volatile memory or a combination thereof.

The processor controls the overall operation of the refrigerator. The processor may control the components of the refrigerator by executing a program stored in the memory. The processor may include a separate NPU that performs the operation of the artificial intelligence model. The processor may include a central processing unit, a graphics-only processor (GPU), and the like. The processor may generate a control signal for controlling the operation of the cold air supply device. For example, the processor may receive temperature information about the storage compartment from the temperature sensor, and generate a cooling control signal for controlling the operation of the cold air supply device based on the temperature information about the storage compartment.

Further, the processor may process the user input of the user interface according to the program and/or data stored/stored in the memory, and control the operation of the user interface. The user interface may be provided using an input interface and an output interface. The processor may receive a user input from the user interface. Further, the processor may transfer a display control signal and image data for displaying an image on the user interface to the user interface in response to the user input.

The processor and the memory may be provided integrally or separately. The processor may include one or more processors. For example, the processor may include a main processor and at least one sub-processor. The memory may include one or more memories.

The refrigerator may include a processor and a memory controlling all components included in the refrigerator, and a plurality of processors and a plurality of memories individually controlling the components of the refrigerator. For example, the refrigerator may include a processor and a memory controlling the operation of the cold air supply device according to the output of the temperature sensor. Further, the refrigerator may include a separate processor and a separate memory controlling the operation of the user interface according to a user input.

The communication module may communicate with an external device such as a server, a mobile device, another home appliance, or the like through an access point (AP). The AP may connect the local area network (LAN) to which the refrigerator or the user equipment is connected to the wide area network (WAN) to which the server is connected. The refrigerator or the user device may be connected to the server through the wide area network (WAN).

The input interface may include a key, a touch screen, a microphone, and the like. The input interface may receive a user input and transfer the user input to the processor.

The output interface may include a display, a speaker, and the like. The output interface may output various notifications, messages, information, and the like generated by the processor.

FIG. 1 is a perspective view illustrating an outer appearance of a refrigerator according to an embodiment of the disclosure.

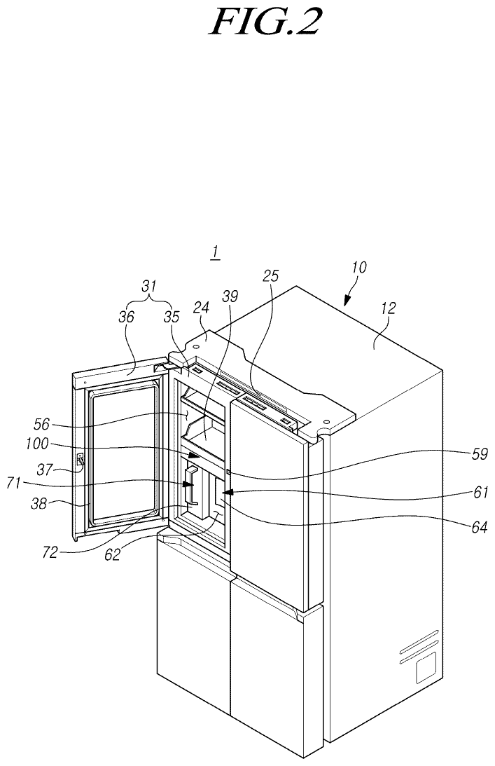

FIG. 2 is a perspective view illustrating an opened outer door of a refrigerator according to an embodiment of the disclosure.

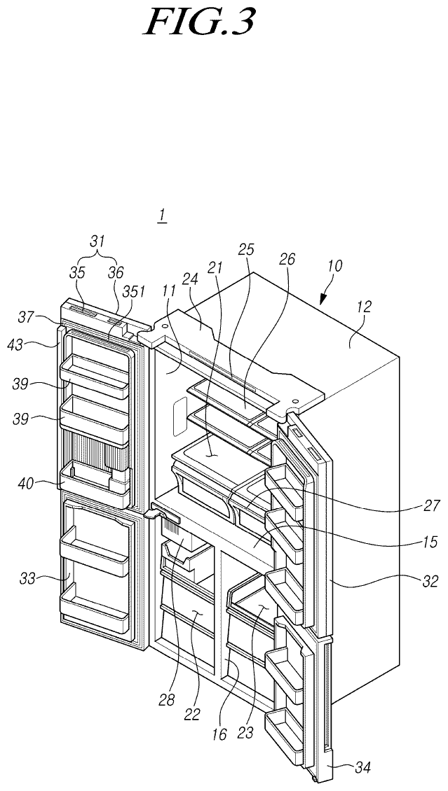

FIG. 3 is a perspective view illustrating an opened inner door of a refrigerator according to an embodiment of the disclosure.

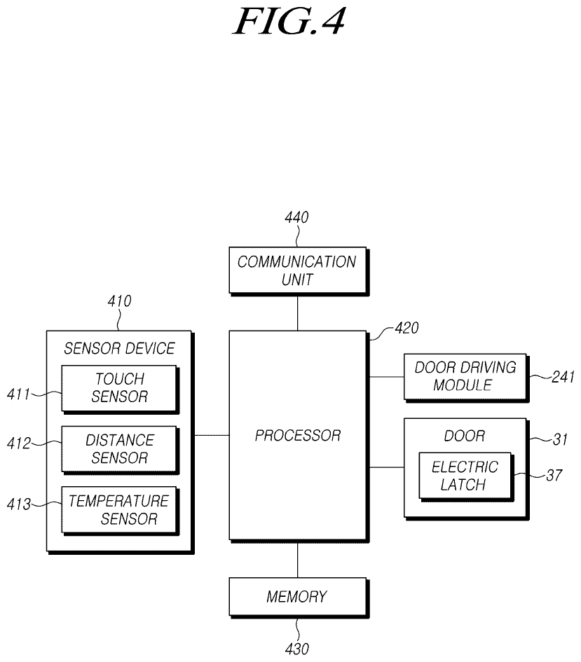

All features, components, and/or arrangement relationships between components illustrated in FIGS. 1 to 3 may be included alone or in combination with the features, components, and arrangement relationships between components described in other drawings of the disclosure. Likewise, all features, components, and/or arrangement relationships between components described in connection with FIGS. 4 to 14 may be included alone or in combination with the features, components, and arrangement relationships between components described in connection with FIGS. 1 and 3.

Referring to FIGS. 1 to 3, a refrigerator 1 according to an embodiment of the disclosure may include a main body 10, storage compartments 21, 22, 23 formed inside the main body 10, doors 31, 32, 33, 34 opening and closing the storage compartments 21, 22, 23, and a cold air supply device (not illustrated) supplying cold air to the storage compartments 21, 22, 23.

According to an embodiment, the main body 10 may include an inner case 11 forming the storage compartments 21, 22, 23, an outer case 12 coupled to the outside of the inner case 11 to form an exterior, and an insulator (not illustrated) disposed between the inner case 11 and the outer case 12 to insulate the storage compartments 21, 22, 23.

According to an embodiment, the storage compartments 21, 22, 23 may be divided into a plurality of compartments by a horizontal partition wall 15 and a vertical partition wall 16. The storage compartments 21, 22, 23 may be divided into an upper storage compartment 21 and lower storage compartments 22, 23 by the horizontal partition wall 15, and the lower storage compartments 22, 23 may be divided into a left lower storage compartment 22 and a right lower storage compartment 23 by the vertical partition wall 16.

According to an embodiment, the upper storage compartment 21 may be used as a refrigerating compartment, and the lower storage compartments 22, 23 may be used as freezing compartments. However, the division and use of the storage compartments 21, 22, 23 as described above is merely an example and is not limited thereto.

According to an embodiment, unlike illustrated, the refrigerator may be a side by side (SBS) type in which storage compartments are divided into left and right ones by a vertical partition wall, a French door refrigerator (FDR) type in which storage compartments are divided into an upper refrigerating compartment and a lower refrigerating compartment by a horizontal partition wall, or a one-door type having one storage compartment and one door.

According to an embodiment, a shelf 26 for placing food and a storage container 27 for storing food may be disposed inside the storage compartments 21, 22, 23.

According to an embodiment, the cold air supply device may generate cold air using a cooling cycle that compresses, condenses, expands, and evaporates refrigerant, and may supply the generated cold air to the storage compartments 21, 22, 23.

According to an embodiment, the upper storage compartment 21 may be opened and closed by a pair of doors 31, 32. The doors 31, 32 may be rotatably coupled to the main body 10. A pillar 43 preventing cold air of the storage compartment 21 from leaking between the pair of doors 31, 32 in case that the pair of doors 31, 32 are closed may be provided on one door 31 of the pair of doors 31, 32.

According to an embodiment, the left lower storage compartment 22 may be opened and closed by a door 33, and the door 33 may be rotatably coupled to the main body 10. The right lower storage compartment 23 may be opened and closed by a door 34, and the door 34 may be rotatably coupled to the main body 10.

According to an embodiment, the doors 31, 32, 33, 34 may include door baskets 39, 40 having a door storage space for storing food. A gasket closely contacting the front surface of the main body 10 to seal the storage compartments 21, 22, 23 may be provided on the rear surface of the doors 31, 32, 33, 34.

According to an embodiment, at least one of the doors 31, 32, 33, and 34 may be configured as a dual-door structure having an inner door 35 and an outer door 36. For example, the left upper door 31 may include an inner door 35 and an outer door 36.

According to an embodiment, the inner door 35 may be rotatably coupled to the main body 10 through a hinge. The inner door 35 may form a door inner space 56. The door inner space 56 may be formed in a central portion except for an edge portion of the inner door 35. The door inner space 56 may be formed to extend between the front and rear surfaces of the inner door 35. Therefore, in case that the inner door 35 is closed, the door inner space 56 may communicate with the storage compartment 21.

According to an embodiment, door baskets 39, 40 may be mounted in the door inner space 56.

According to an embodiment, a dispenser 61 may be provided in the door inner space 56. The dispenser 61 may include an operating lever 64 that may be operated to dispense water by operating the dispenser 61. A user may press the operating lever 64 using a container (not illustrated) such as a cup. The operating lever 64 may be movably installed in a lever installation portion 110 formed in a water supply case 100.

According to an embodiment, the refrigerator 1 may include an automatic water supply device 71. The automatic water supply device 71 may be disposed in the door inner space 56. The automatic water supply device 71 may be configured to automatically supply water to a water bottle 72 so that a predetermined amount of water is filled in the water bottle 72 in case that the water bottle 72 is mounted in a water bottle mounting space. In other words, the automatic water supply device 71 may have an auto-fill function. The predetermined amount may be about a full water amount of the water bottle 72.

According to an embodiment, the dispenser 61, the automatic water supply device 71, and the water supply case 100 may be provided as one assembly. In the disclosure, such an assembly may be referred to as a water supply unit or a water supply assembly.

According to an embodiment, the water supply unit may be disposed in the door inner space 56 of the inner door 35. Specifically, the water supply case 100 of the water supply unit may be mounted on a door inner surface forming the door inner space 56.

According to an embodiment, in case that the inner door 35 is closed, the door inner space 56 communicates with the storage compartment 21, so the water supply unit may be cooled by cold air of the storage compartment 21. Further, a water intake space 62 and a space where the water bottle 72 is mounted may be formed on the front surface of the water supply case 100. Therefore, by opening the outer door 36 with the inner door 35 closed, access to the water intake space 62 and the space where the water bottle 72 is mounted may be possible.

According to an embodiment, the outer door 36 may be disposed to open and close the door inner space 56 of the inner door 35. The outer door 36 may be coupled to be rotatable relative to the inner door 35. The rear surface of the outer door 36 may include a gasket 38 to seal the door inner space 56. The gasket 38 may closely contact the front surface of the inner door 35 around the door inner space 56.

According to an embodiment, in case that the outer door 36 is opened, access to the door inner space 56 of the inner door 35 may be possible. The outer door 36 may be rotatably coupled to the inner door 35 through a hinge. The outer door 36 may rotate in the same direction as the inner door 35. For example, the outer door 36 may have a size corresponding to the size of the inner door 35. For example, the outer door 36 may be disposed to cover the entire area of the inner door 35.

According to an embodiment, the outer door 36 may include an electric latch 37. The latch 37 may be provided to be fixed to the inner door 35 in a closed state. The inner door 35 may include a catch 59 disposed to engage with the latch 37.

According to an embodiment, in case that the outer door 36 is opened in a state in which the latch 37 and the catch 59 are engaged or fastened, the outer door 36 and the inner door 35 open together and, in case that the outer door 36 is opened in a state in which the latch 37 and the catch 59 are not engaged, only the outer door 36 may open and the inner door 35 may not open.

According to an embodiment, the latch 37 may be an electric latch. The latch 37 may be an electric device that engages or disengages with the catch 59 by an electrical signal. The latch 37 may include an actuator for engaging or disengaging with the catch 59.

According to an embodiment, a decorative panel (not shown) may be detachably coupled to the front surface of the outer door 36.

According to an embodiment, a top or upper cover 24 may be coupled to an upper surface of the main body 10. The upper cover 24 may be disposed to cover a hinge and various electrical components disposed on the upper surface of the main body 10. A control panel 25 that may display various states and operation information of the refrigerator 1 or input various commands for operation of the refrigerator 1 may be provided on the front surface of the upper cover 24. The upper cover 24 may be disposed to cover a door driving module 241 that may automatically open the doors 31, 32. The door driving module 241 may be configured to open the doors 31, 32 by pressing the doors 31, 32 using a pusher (or push rod) disposed to move forward and backward. The door driving module 241 may be configured to rotate a hinge coupled to the doors 31, 32 by driving a motor.

FIG. 4 is a control block diagram illustrating a refrigerator according to an embodiment.

All features, components, and/or arrangement relationships between components illustrated in FIG. 4 may be included alone or in combination with the features, components, and arrangement relationships between components described in other drawings of the disclosure. Likewise, all features, components, and/or arrangement relationships between components described in connection with FIGS. 1 to 3 and 5 to 14 may be included alone or in combination with the features, components, and arrangement relationships between components described in connection with FIG. 4.

Referring to FIG. 4, a refrigerator 1 according to an embodiment may include at least one of at least one sensor device 410, at least one processor 420, a memory 430, a communication unit 440, a door driving module 241, or a door 31. The door 31 may include an electric latch 37. The door 31 may include a first door (e.g., the first door 35 of FIG. 3) and a second door (e.g., the second door 36 of FIG. 3).

According to an embodiment, the at least one sensor device 410 may include at least one of a temperature sensor 413, a touch sensor 411, or a distance sensor 412. The illustrated sensors are exemplary, and the types of sensors included in the refrigerator 1 are not limited thereto.

According to an embodiment, the temperature sensor 413 may include at least one temperature sensor sensing a temperature inside the storage compartments 21, 22, 23. For example, the temperature sensor 413 may include at least one temperature sensor sensing an external temperature around the refrigerator 1.

According to an embodiment, at least one temperature sensor may be installed in each of the plurality of storage compartments 21, 22, 23 to sense the temperature of each of the plurality of storage compartments 21, 22, 23, and may output an electrical signal corresponding to the sensed temperature to the at least one processor 420. Each of the at least one temperature sensors may include a thermistor whose electrical resistance changes according to temperature.

According to an embodiment, the touch sensor 411 may be disposed on one door of the first door 35 or the second door 36. The touch sensor 411 may use, e.g., at least one of a capacitive, pressure-sensitive, infrared, or ultrasonic method.

According to an embodiment, the distance sensor 412 may be disposed to sense a degree of push of the door 31. For example, the distance sensor 412 may include at least one of a radar sensor, an optical sensor, or an ultrasonic sensor. For example, the distance sensor 412 may include at least one of a light detection and ranging (LiDAR) sensor, a structured light sensor, a laser scanner, or a camera sensor.

According to an embodiment, the distance sensor 412 may be disposed at the edge portion of the main body 10 or the edge portion of the door. The edge portion of the main body 10 may be spaced apart from the door 31 by a predetermined distance by a gasket 38 in a state in which the door 31 is closed. The distance sensor 412 disposed at the edge portion of the main body 10 may continuously sense the distance to the door 31, and the at least one processor 420 may sense that the distance between the main body 10 and the door 31 decreases in case that a user pushes the door 31 using the distance sensor 412.

According to an embodiment, the at least one sensor device 410 may further include a door open/close sensor. The door open/close sensor may be disposed near a hinge coupling the door 31 and the main body 10, or may be disposed at a portion of the door 31 or a portion of the main body 10 where the door 31 and the main body 10 contact.

According to an embodiment, the door open/close sensor may output whether the door 31 is open or closed as a preset determination value. For example, the door open/close sensor may be configured to output 1 in case that the door 31 is open and output 0 in case that the door 31 is closed. For example, the door open/close sensor may include one of a position sensor, a reed switch, or a magnetic sensor, but the disclosure is not limited thereto.

According to an embodiment, the at least one processor 420 may process sensing data of the at least one sensor device 410 and/or communication data of the communication unit 440 according to a program and/or data stored/saved in the memory 430. The at least one processor 420 may generate a control signal for controlling the operation of the door driving module 241 and/or the electric latch 37 based on data processing. The at least one processor 420 may each include at least one processing circuit.

According to an embodiment, the at least one processor 420 may include at least one of circuits such as a central processing unit (CPU), microprocessor unit (MPU), graphics processing unit (GPU), accelerated processing unit (APU), digital signal processor (DSP), field-programmable gate array (FPGA), control processor (CP), application processor (AP), system on chip (soc), or integrated circuit (IC).

According to an embodiment, the memory 430 may store/memorize a program and/or data. The memory 430 may store/memorize a program and/or data. The program may include a plurality of instructions combined to perform a specific function. The data may be processed and/or manipulated by the plurality of instructions included in the program. Further, the program and/or data may include system programs and/or system data directly related to the operation of the refrigerator 1, and application programs and/or application data that provide convenience to the user. The program and/or data may be referred to as instructions.

According to an embodiment, the memory 430 may include a non-volatile memory storing a program and/or data for controlling the components included in the refrigerator 1 and a volatile memory storing temporary data generated during controlling the components included in the refrigerator 1.

The non-volatile memory may store programs and/or data, e.g., electrically, magnetically or optically. The non-volatile memory may include, e.g., a read only memory or flash memory for storing data for a long time. The non-volatile memory may also include a solid state drive (SSD), a hard disk drive (HDD), or an optical disc drive (ODD).

The volatile memory may load the program and/or data from the non-volatile memory, e.g., and may electrically store the program and/or data. The volatile memory may include, e.g., static random access memory (S-RAM) and/or dynamic random access memory (D-RAM) for temporarily storing data.

According to an embodiment, the memory 430 may store/save programs and data such as an operating system (OS), middleware, and applications, and may provide programs and data (hereinafter, instructions) to the processor 420 in response to a request from the processor 420.

According to an embodiment, the communication unit 440 may exchange data with external devices such as a server device and/or a user device.

According to an embodiment, the communication unit 440 may include a wired communication module wiredly exchanging data with external devices and a wireless communication module wirelessly exchanging data with external devices.

The wired communication module may connect to a wired communication network and communicate with external devices through the wired communication network. For example, the wired communication module may connect to a wired communication network through Ethernet and receive data from external devices through the wired communication network.

The wireless communication module may communicate wirelessly with a base station or an access point (AP), and may connect to a wired communication network through the base station or access point. The wireless communication module may also communicate with the external devices connected to the wired communication network via the base station or the access point. For example, the wireless communication module may communicate wirelessly with an access point (AP) using Wi-Fi, or communicate with a base station using CDMA, WCDMA, GSM, long term evolution (LTE), or WiBro. The wireless communication module may also receive data from the external devices via the base station or the access point. Further, the wireless communication module may directly communicate with the external devices. For example, the wireless communication module may wirelessly receive data from external devices using Wi-Fi, Bluetooth, or ZigBee.

According to an embodiment, the communication unit 440 may transmit/receive data with external devices, and may transfer received data to the processor 420.

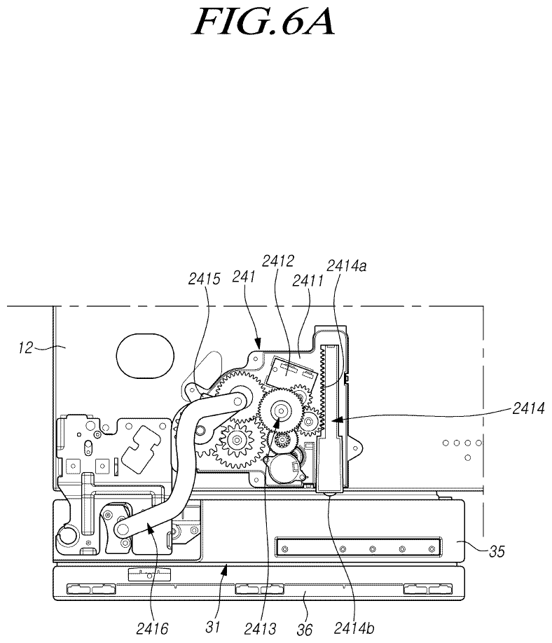

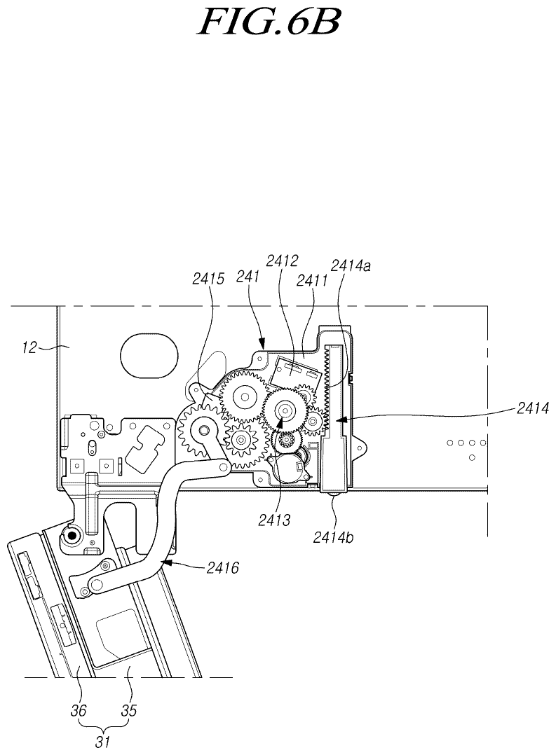

According to an embodiment, the door driving module 241 may be disposed to control the opening or closing of a door. The door driving module 241 may include at least one motor. The door driving module 241 may be configured to transfer power of the motor to a pusher (e.g., the pusher 2414 of FIG. 6A) or a closing arm (e.g., the closing arm 2416 of FIG. 6A) in case that at least one motor rotates. The door driving module 241 may include a gear assembly for power transmission between the motor and the pusher 2414, and between the motor and the closing arm 2416. The specific structure of the door driving module 241 is described below.

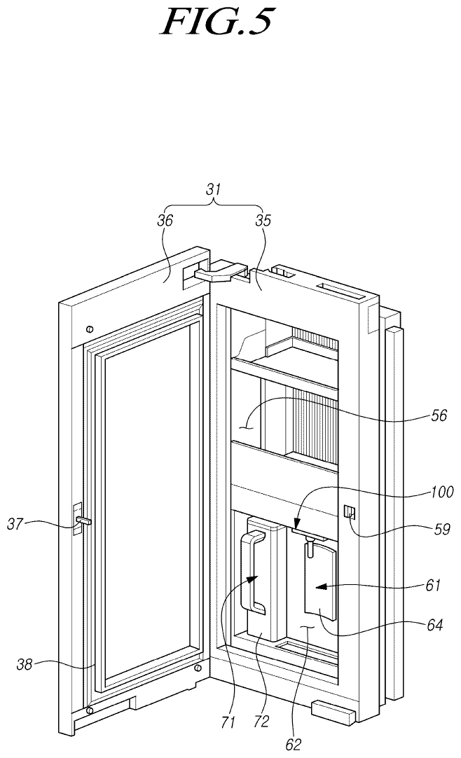

According to an embodiment, the electric latch 37 may engage the second door (e.g., the second door 36 of FIG. 2) and the first door (e.g., the first door 35 of FIG. 2) by engaging with a catch (e.g., the catch 59 of FIG. 5). In case that the second door 36 is engaged with the first door 35, the second door 36 may be positioned in a closed state relative to the first door 35.

According to an embodiment, the electric latch 37 may be configured to disengage from the catch 59 by an electrical signal. For example, the electric latch 37 may include an actuator operating in response to an electrical signal. The electric latch 37 may receive an electrical signal from the at least one processor 420 and perform an operation of disengaging from the catch 59.

According to an embodiment, the at least one processor 420 may be operated by instructions stored in the memory 430.

According to an embodiment, the instructions stored in the memory 430 may include an operation of sensing a motion of a user using the at least one sensor device 410.

According to an embodiment, the instructions stored in the memory 430 may include an operation of performing one mode of a first open mode or a second open mode based on the motion of the user. Here, the first open mode and the second open mode may be modes performed in a state in which the first door (e.g., the first door 35 of FIG. 2) and the second door (e.g., the second door 36 of FIG. 2) are closed. For example, the first open mode may be an operation of opening the first door 35. The first open mode may be an operation of rotating the first door 35 and the second door 36 together about a hinge. The second open mode may be an operation of opening the second door 36. In the second open mode, the first door 35 may maintain a closed state while the second door 36 is opened. For example, the first open mode may be referred to as a first door 35 opening operation. For example, the second open mode may be referred to as a second door 36 opening operation. The operations of the first open mode and the second open mode are exemplary and are not limited thereto.

According to an embodiment, the instructions may include an operation of controlling the door driving module 241 to automatically open the first door 35 and the second door 36. For example, in the first open mode, the door driving module 241 may be operated to open the first door 35. In case that the first door 35 is opened by the door driving module 241, the second door 36 may also rotate about the hinge together with the first door 35. For example, in the second open mode, the second door 36 may be opened by operating the door driving module 241 and transferring an electrical signal to the electric latch 37 to release the engagement between the first door 35 and the second door 36. Here, the pusher (e.g., the pusher 2414 of FIG. 6A) of the door driving module 241 may be disposed to press the edge of the second door 36.

According to an embodiment, the instructions may include an operation of sensing a motion of a user using at least one sensor of the touch sensor 411 or the distance sensor 412. For example, in case that the refrigerator 1 includes the touch sensor 411 and the distance sensor 412, the instructions may include an operation of performing the first open mode or the second open mode by sensing a touch motion or a push motion of a user. For example, in case that the refrigerator 1 includes the touch sensor 411, the instructions may include an operation of performing the first open mode or the second open mode by sensing the number of touches of a user on the door 31. For example, in case that the refrigerator 1 includes the distance sensor 412, the instructions may include an operation of performing the first open mode or the second open mode by sensing a push time of a user on the door 31. A method of sensing a push motion of the door 31 using the distance sensor 412 is described below.

FIG. 5 is a view illustrating an outer door and an inner door of a refrigerator according to an embodiment.

FIGS. 6A and 6B are views illustrating an internal structure of a door driving device of a refrigerator according to an embodiment.

All features, components, and/or arrangement relationships between components illustrated in FIGS. 5 to 6B may be included alone or in combination with the features, components, and arrangement relationships between components described in other drawings of the disclosure. Likewise, all features, components, and/or arrangement relationships between components described in connection with FIGS. 1 to 4 and 7 to 14 may be included alone or in combination with the features, components, and arrangement relationships between components described in connection with FIGS. 5 to 6B.

Referring to FIGS. 5, 6A, and 6B, a refrigerator 1 according to an embodiment may include the outer case 12 of the main body, a door driving module 241, a first door 35, and a second door 36. Although FIGS. 5, 6A, and 6B describe one door driving module 241 for one door 31, the door driving module 241 may also be disposed one each for other doors.

According to an embodiment, the door driving module 241 may include at least one of a module housing 2411, a first motor 2412, a gear assembly 2413, a pusher 2414, a second motor 2415, or a closing arm 2416. Here, the pusher 2414 may be referred to as a push rod.

According to an embodiment, the first motor 2412 may be disposed to transfer power to the pusher 2414. The first motor 2412 may be disposed within the module housing 2411.

According to an embodiment, the pusher 2414 may be disposed to receive power from the first motor 2412 and press the first door 35 or the second door 36. For example, the pusher 2414 may be disposed to press the second door 36. The pusher 2414 may be disposed within the module housing 2411.

According to an embodiment, the gear assembly 2413 may be disposed to transfer power of the first motor 2412 to the pusher 2414. Some gears of the gear assembly 2413 may be disposed to transfer power of the first motor 2412 to the pusher 2414. The gear assembly 2413 may be disposed within the module housing 2411.

According to an embodiment, the pusher 2414 may include a rack gear portion 2414a and a pressing portion 2414b. The rack gear portion 2414a may be disposed to mesh with a gear of the gear assembly 2413. The rack gear portion 2414a allows the pusher 2414 to receive rotational force of the gear and move linearly. The pressing portion 2414b may be a portion pressing the first door 35 or the second door 36. The pressing portion 2414b may be disposed to face the direction toward the first door 35 or the second door 36. The pressing portion 2414b may be positioned at a portion corresponding to the edge portion of the first door 35 or the edge portion of the second door 36. In case that the pressing portion 2414b presses the first door 35 or the second door 36, at least one door of the first door 35 or the second door 36 may be opened.

According to an embodiment, the second motor 2415 may be disposed to transfer power to the closing arm 2416. The second motor 2415 may be disposed within the module housing 2411.

According to an embodiment, the closing arm 2416 may have one end coupled to a portion of the gear assembly 2413 and the other end coupled to the first door 35. The closing arm 2416 may be disposed to move together according to the rotation of the first door 35.

According to an embodiment, the closing arm 2416 may be configured to receive power from the second motor 2415 to close the first door 35. The closing arm 2416 may close the first door 35 by rotating with power received from the second motor 2415 to rotate the first door 35 about the hinge.

According to an embodiment, the closing arm 2416 may move together according to the rotation of the first door 35. For example, in case that a user manually closes the first door 35 by applying force in case that the first door 35 is in an open state, the closing arm 2416 may also rotate together with the first door 35. Gears coupled to the closing arm 2416 may also rotate according to the rotation of the closing arm 2416. The second motor 2415 may be rotated by the rotation of the gears. Here, the at least one processor (e.g., the processor 420 of FIG. 4) may determine that the first door 35 is being manually closed based on a current load applied to the second motor 2415.

According to an embodiment, the electric latch 37 may be disposed on the second door 36 but, without limitations thereto, may be disposed on the first door 35. The catch corresponding to the electric latch 37 may be disposed on the first door 35 but, without limitations thereto, may be disposed on the second door 36. The electric latch 37 may perform an operation of disengaging from the catch 59 based on an electrical signal received from the at least one processor 420. In case that the engagement between the electric latch 37 and the catch 59 is released, the second door 36 may rotate relative to the first door 35. In case that the engagement between the electric latch 37 and the catch 59 is released, the second door 36 may be rotated to open and close the door inner space 56 of the first door 35.

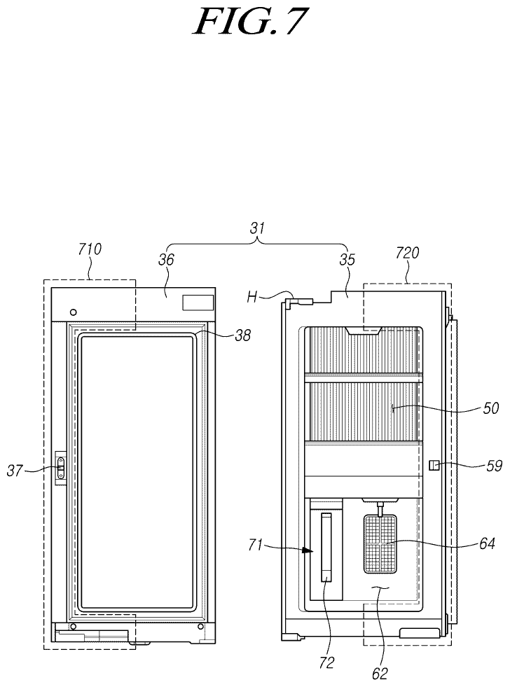

FIG. 7 is a view illustrating an outer door and an inner door of a refrigerator separated in an unfolded state according to an embodiment.

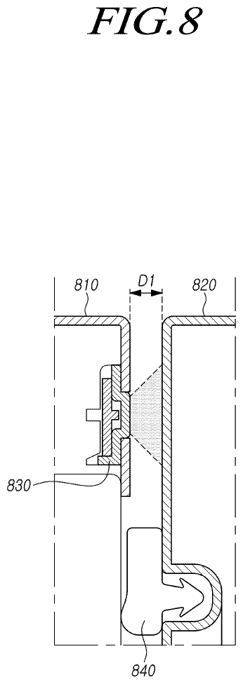

FIG. 8 is a cross-sectional view schematically illustrating an operation of detecting a push using a distance sensor of a refrigerator according to an embodiment.

All features, components, and/or arrangement relationships between components illustrated in FIGS. 7 and 8 may be included alone or in combination with the features, components, and arrangement relationships between components described in other drawings of the disclosure. Likewise, all features, components, and/or arrangement relationships between components described in connection with FIGS. 1 to 6B and 9 to 14 may be included alone or in combination with the features, components, and arrangement relationships between components described in connection with FIGS. 7 and 8.

Referring to FIG. 7, a refrigerator (e.g., the refrigerator 1 of FIG. 1) according to an embodiment may include a door 31. The door 31 illustrated in FIG. 7 may be substantially the same as the door 31 illustrated in FIGS. 1 to 6B. FIG. 7 is an exemplary view for describing an area where a distance sensor (e.g., the distance sensor 412 of FIG. 4) is mounted.

According to an embodiment, the distance sensor 412 may be disposed in a first area 720 which is a partial area of the edge portion of the first door 35 or a partial area 710 of the edge portion of the second door 36.

According to an embodiment, the distance sensor 412 may be disposed outside the gasket 38. In a closed state of the second door 36, i.e., in a state engaged with the first door 35, the gasket 38 may closely contact one surface of the first door 35. In this case, the edge of the first door 35 and the edge of the second door 36, which are the outer portions of the gasket 38, may be spaced apart from each other. The distance sensor 412 may be disposed outside the gasket 38 to sense a change in the gap between the first door 35 and the second door 36. The at least one processor 420 may determine whether a user has pushed the door 31 based on a value sensed by the distance sensor 412.

According to an embodiment, in case that the distance sensor 412 is disposed in the first area 720, it may be disposed to face the second door 36. According to an embodiment, in case that the distance sensor 412 is disposed in the second area 710, it may be disposed to face the first door 35.

According to an embodiment, the first area 720 and the second area 710 may be areas spaced apart from the hinge H by a predetermined distance or more. Since the first door 35 and the second door 36 rotate about the hinge H as an axis, the farther from the hinge H, the greater the displacement change according to door push, allowing the processor 420 to more accurately determine whether there is a push.

FIG. 8 schematically illustrates a method by which the processor 420 determines whether there is a push using the distance sensor 830. Although FIG. 8 describes the case where the distance sensor 830 is disposed on the first door 810 as an example, the description of FIG. 8 may be equally applied to the case where it is disposed on the second door 820.

Referring to FIG. 8, the distance sensor 412 may sense a displacement D1 between the first door 810 and the second door 820 in case that the first door 810 (e.g., the first door 35 of FIG. 7) and the second door 820 (e.g., the second door 36 of FIG. 7) are engaged with each other (or in a closed state). In case that a user pushes the door, the displacement D1 between the first door 810 and the second door 820 may decrease as the gasket 840 (e.g., the gasket 38 of FIG. 7) is compressed. The at least one processor 420 may sense such a change in the displacement D1 using the distance sensor 830, and may determine a door push state in case of determining that the displacement D1 between the first door 810 and the second door 820 has become smaller than a reference displacement.

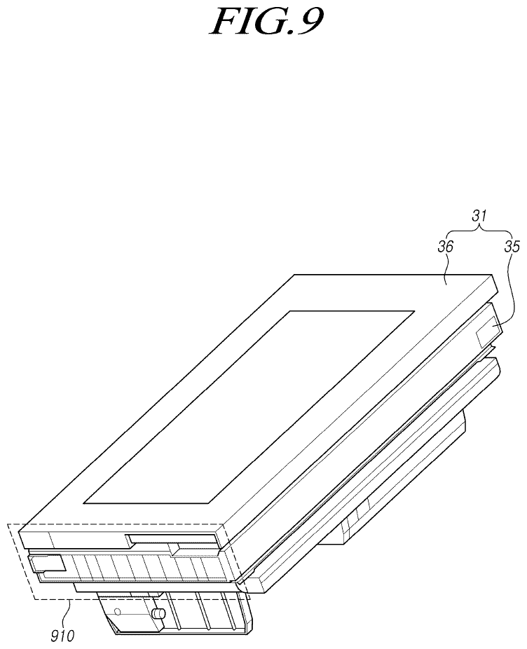

FIG. 9 is a perspective view illustrating a door of a refrigerator viewed from below according to an embodiment.

All features, components, and/or arrangement relationships between components illustrated in FIG. 9 may be included alone or in combination with the features, components, and arrangement relationships between components described in other drawings of the disclosure. Likewise, all features, components, and/or arrangement relationships between components described in connection with FIGS. 1 to 8 and 10 to 14 may be included alone or in combination with the features, components, and arrangement relationships between components described in connection with FIG. 9.

The door 31 of FIG. 9 may be substantially the same as the door (e.g., the door 31 of FIG. 3) of FIG. 3. In FIG. 9, only one door among the plurality of doors mounted on the refrigerator 1 is illustrated as an example to describe the mounting position of the touch sensor (e.g., the touch sensor 411 of FIG. 4), but it may be similarly applied to other doors not illustrated.

Referring to FIG. 9, a touch sensor 411 according to an embodiment may be disposed in a lower area 910 of the door 31. For example, the touch sensor 411 may be disposed at a lower portion of the first door 35. For example, the touch sensor 411 may be disposed at a lower portion of the second door 36. The door 31 illustrated in FIG. 9 is a door disposed at the upper portion of the main body 10 among the plurality of doors 31, 32, 33, 34 provided in the refrigerator 1, and the touch sensor 411 may be disposed at the lower portion of the door 31, which is a position convenient for a user to use. However, this is not limited, and in the case of a door disposed at the lower portion of the main body 10, the touch sensor 411 may be disposed at the upper portion of the door.

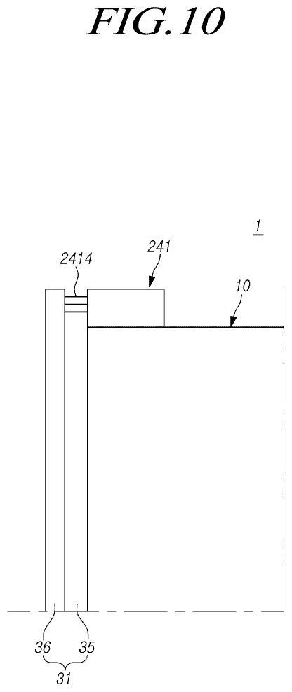

FIG. 10 is a schematic view illustrating a first open mode and a second open mode of a refrigerator according to an embodiment.

All features, components, and/or arrangement relationships between components illustrated in FIG. 10 may be included alone or in combination with the features, components, and arrangement relationships between components described in other drawings of the disclosure. Likewise, all features, components, and/or arrangement relationships between components described in connection with FIGS. 1 to 9 and 11 to 14 may be included alone or in combination with the features, components, and arrangement relationships between components described in connection with FIG. 10.

FIG. 10 is a schematic diagram for exemplarily describing an operation in which the refrigerator 1 according to an embodiment selectively opens one of the first door 35 or the second door 36, and the disclosure is not limited by the illustrated structure.

According to an embodiment, the pusher 2414 may be disposed to press the second door 36.

According to an embodiment, the pusher 2414 may open one door of the first door 35 or the second door 36 by moving forward in the direction toward the door 31. For example, in case of performing the first open mode, the pusher 2414 moves forward in the direction toward the second door 36 and presses the second door 36 in a state in which the first door 35 and the second door 36 are engaged by the electric latch 37 and the catch 59, thereby rotating the first door 35 and the second door 36 together, and as a result, the first door 35 may be opened to open the main body 10. For example, in case of performing the second open mode, the pusher 2414 presses the second door 36 in a state in which the first door 35 and the second door 36 are disengaged, thereby rotating the second door 36, and as a result, the second door 36 may be opened to open the door inner space 56 of the first door 35.

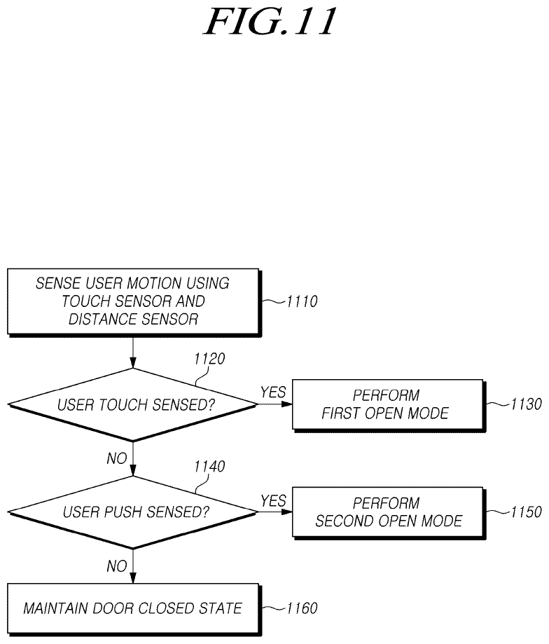

FIG. 11 is a flowchart illustrating an automatic door opening and closing operation using a touch sensor and a distance sensor according to an embodiment.

All features, components, and/or arrangement relationships between components illustrated in FIG. 11 may be included alone or in combination with the features, components, and arrangement relationships between components described in other drawings of the disclosure. Likewise, all features, components, and/or arrangement relationships between components described in connection with FIGS. 1 to 10 and 12 to 14 may be included alone or in combination with the features, components, and arrangement relationships between components described in connection with FIG. 11.

The refrigerator 1 performing the control method illustrated in FIG. 11 may include a touch sensor (e.g., the touch sensor 411 of FIG. 4) and a distance sensor (e.g., the distance sensor 412 of FIG. 4).

Referring to FIG. 11, the refrigerator 1 according to an embodiment may perform an operation 1110 of sensing a motion of a user using the touch sensor 411 and the distance sensor 412. The at least one processor 420 may determine whether a user has touched the touch sensor 411 or whether a user has pushed the door 31 using the touch sensor 411 and the distance sensor 412 disposed on the door 31.

According to an embodiment, the refrigerator 1 may perform an operation 1120 of determining whether a touch of a user has been sensed. The at least one processor 420 may sense or determine whether a user has touched the touch sensor 411 using the touch sensor 411.

According to an embodiment, the refrigerator 1 may perform an operation 1130 of performing the first open mode in case of sensing a touch of a user. Here, the first open mode may refer to an operation of opening the first door 35. In case that the first door 35 is opened, the second door 36 engaged with the first door 35 may also be opened together.

According to an embodiment, the refrigerator 1 may perform an operation 1140 of determining whether a push of a user has been sensed in case that a touch of a user has not been sensed. The at least one processor 420 may sense or determine whether a user has pushed the door 31 using the distance sensor 412.

Operations 1120 and 1140 do not necessarily have to proceed in the order illustrated in FIG. 11, and operations 1120 and 1140 may be performed simultaneously, or operation 1140 may be performed before operation 1120.

According to an embodiment, the refrigerator 1 may perform an operation 1150 of performing the second open mode in case of sensing a push of a user. Here, the second open mode may refer to an operation of opening the second door 36. The first door 35 may maintain a closed state while the second door 36 is opened. The specific operations of the first open mode and the second open mode are not limited thereto.

According to an embodiment, the refrigerator 1 may maintain a door closed state in case that a push of a user has not been sensed. In this case, the refrigerator 1 may determine that there is no motion of a user for door opening and maintain the door in a closed state.

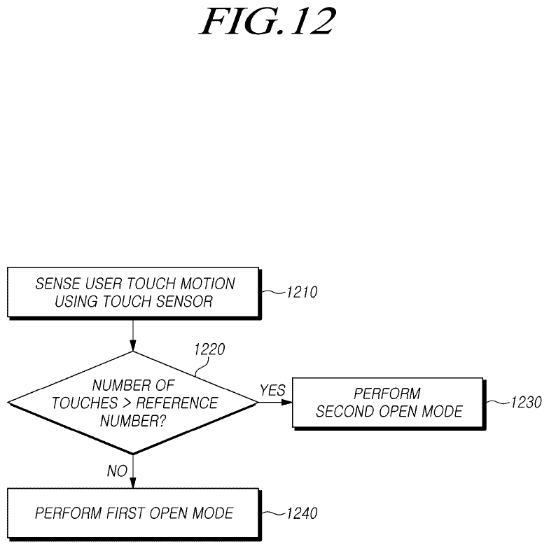

FIG. 12 is a flowchart illustrating an automatic door opening and closing operation using a touch sensor according to an embodiment.

All features, components, and/or arrangement relationships between components illustrated in FIG. 12 may be included alone or in combination with the features, components, and arrangement relationships between components described in other drawings of the disclosure. Likewise, all features, components, and/or arrangement relationships between components described in connection with FIGS. 1 to 11 and 13 and 14 may be included alone or in combination with the features, components, and arrangement relationships between components described in connection with FIG. 12.

The refrigerator 1 performing the control method illustrated in FIG. 12 may include a touch sensor (e.g., the touch sensor 411 of FIG. 4). FIG. 12 describes an operation in which the refrigerator 1 according to an embodiment performs the first open mode and the second open mode using one sensor device.

Referring to FIG. 12, the refrigerator 1 according to an embodiment may include an operation 1210 of sensing a user touch motion using the touch sensor 411.

According to an embodiment, the refrigerator 1 may include an operation 1220 of measuring the number of touches of a user and determining whether the number of touches exceeds a reference number. Operation 1220 may be performed in case that the number of touches sensed by the at least one processor 420 using the touch sensor 411 is at least once.

According to an embodiment, the refrigerator 1 may perform an operation 1230 of performing the second open mode in case of determining that the number of touches of a user has exceeded the reference number.

According to an embodiment, the refrigerator 1 may perform an operation 1240 of performing the first open mode in case of determining that the number of touches of a user is equal to or less than the reference number.

For example, the reference number may be once. In case that the reference number is one, a user may perform the first open mode by touching the touch sensor 411 once, and may perform the second open mode by touching twice or more. Here, the first open mode may refer to an operation of opening the first door 35. In case that the first door 35 is opened, the second door 36 engaged with the first door 35 may also be opened together. Here, the second open mode may refer to an operation of opening the second door 36. The first door 35 may maintain a closed state while the second door 36 is opened. The specific operations of the first open mode and the second open mode are not limited thereto.

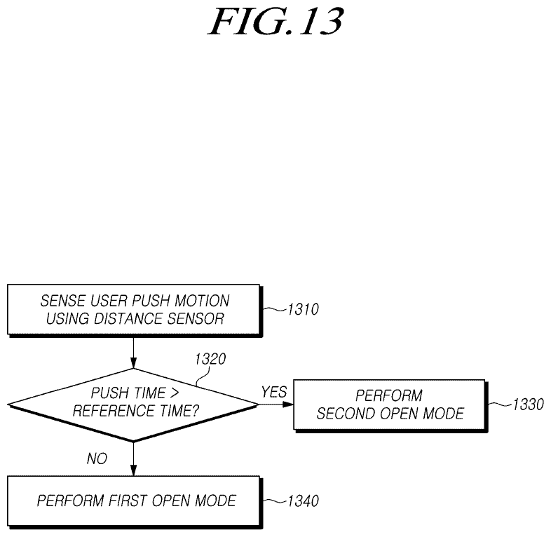

FIG. 13 is a flowchart illustrating an automatic door opening and closing operation using a distance sensor according to an embodiment.

All features, components, and/or arrangement relationships between components illustrated in FIG. 13 may be included alone or in combination with the features, components, and arrangement relationships between components described in other drawings of the disclosure. Likewise, all features, components, and/or arrangement relationships between components described in connection with FIGS. 1 to 12 and 14 may be included alone or in combination with the features, components, and arrangement relationships between components described in connection with FIG. 13.

The refrigerator 1 performing the control method illustrated in FIG. 13 may include a distance sensor (e.g., the distance sensor 412 of FIG. 4). FIG. 13 describes an operation in which the refrigerator 1 according to an embodiment performs the first open mode and the second open mode using one sensor device.

Referring to FIG. 13, the refrigerator 1 according to an embodiment may include an operation 1310 of sensing a user push motion using the distance sensor 412. A method of sensing a touch motion of a user using the distance sensor 412 is described in detail in FIG. 8.

According to an embodiment, the refrigerator 1 may perform an operation 1320 of determining whether a push time of a user measured using the distance sensor 412 exceeds a reference time.

According to an embodiment, the refrigerator 1 may perform an operation 1330 of performing the second open mode in case of determining that the push time has exceeded the reference time.

According to an embodiment, the refrigerator 1 may perform an operation 1340 of performing the first open mode in case of determining that the push time is equal to or less than the reference time.

For example, the reference time may be 1 second. In case that the reference time is 1 second, a user may perform the first open mode by pushing the distance sensor 412 for 1 second or less, and may perform the second open mode by pushing for more than 1 second. Here, the first open mode may refer to an operation of opening the first door 35. In case that the first door 35 is opened, the second door 36 engaged with the first door 35 may also be opened together. Here, the second open mode may refer to an operation of opening the second door 36. The first door 35 may maintain a closed state while the second door 36 is opened. The specific operations of the first open mode and the second open mode are not limited thereto.

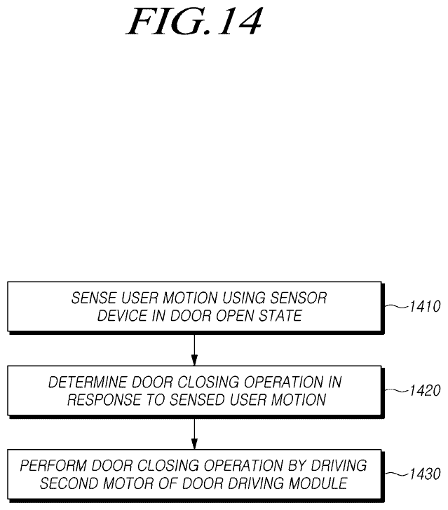

FIG. 14 is a flowchart illustrating an automatic door closing operation of a refrigerator according to an embodiment.

All features, components, and/or arrangement relationships between components illustrated in FIG. 14 may be included alone or in combination with the features, components, and arrangement relationships between components described in other drawings of the disclosure. Likewise, all features, components, and/or arrangement relationships between components described in connection with FIGS. 1 to 13 may be included alone or in combination with the features, components, and arrangement relationships between components described in connection with FIG. 14.

According to an embodiment, the refrigerator 1 may perform an operation 1410 of sensing a motion of a user using a sensor device (e.g., the sensor device 410 of FIG. 4) in a door open state. Here, the sensor device 410 may include at least one of the touch sensor 411 or the distance sensor 412.

According to an embodiment, the refrigerator 1 may determine a door closing operation 1420 in response to the sensed user motion. For example, in case that a user touches the touch sensor 411 in a door open state, the refrigerator 1 may sense this and determine a door closing operation. For example, in case that a user touches the distance sensor 412 in a door open state, the refrigerator 1 may sense this and determine a door closing operation.

Although not illustrated, in operation 1420, the refrigerator 1 may sense an operation of a user pushing to close the door and determine a door closing operation. For example, in case that a user presses the door to manually close the door, the pressed force is transferred to the closing arm 2416 coupled to the door, and as a result, the pressed force may also be transferred to the second motor 2415 connected to the closing arm 2416. The refrigerator 1 may determine a closing operation of a user by measuring a current load applied to the second motor 2415.

According to an embodiment, the refrigerator 1 may perform a door closing operation by driving the second motor (e.g., the second motor 2415 of FIG. 6A) of the door driving module (e.g., the door driving module 241 of FIG. 6A). In case that a door closing operation is determined in operation 1420, the refrigerator 1 may perform a door closing operation by driving the second motor 2415 of the door driving module 241. The refrigerator 1 may perform an operation of closing the door from a door open state using the door driving module 241. For example, the refrigerator 1 may perform control to transfer power to the closing arm (e.g., the closing arm 2416 of FIG. 6A) by operating the second motor 2415 of the door driving module 241. The closing arm 2416 has one end coupled to the first door (e.g., the first door 35 of FIG. 6A) and may rotate the first door 35 in a closing direction.

A refrigerator 1 according to an embodiment may include a main body 10 forming an inner space, a first door 35 including a door inner space 56 and disposed to open and close the main body 10, a second door 36 disposed to be rotatable relative to the first door 35 to open and close the door inner space 56, a door driving module 241 disposed to rotate at least one of the first door 35 or the second door 36, an electric latch 37 disposed to engage the first door 35 and the second door 36, at least one sensor device 410, at least one processor 420 including at least one processing circuit, and a memory 430 including instructions stored to operate the at least one processor 420. The instructions may include an operation of sensing a motion of a user using the at least one sensor device 410, and an operation of performing one of an operation of opening the first door 35 or an operation of opening the second door 36 based on the motion of the user in a state in which the first door 35 and the second door 36 are closed.

According to an embodiment, in the operation of opening the first door 35, the door driving module 241 is operated to open the first door 35, and in the operation of opening the second door 36, the second door 36 may be opened by transferring an electrical signal to the electric latch 37 to release the engagement between the first door 35 and the second door 36.

According to an embodiment, the at least one sensor device 410 may include a touch sensor 411 and a distance sensor 412. The instructions may perform an operation of opening the first door 35 in case of detecting a touch using the touch sensor 411, and may perform an operation of opening the second door 36 in case of detecting a door push using the distance sensor 412.

According to an embodiment, the second door 36 may include a gasket 38 and the distance sensor 412 may be disposed outside the gasket 38 on the first door 35.

According to an embodiment, the instructions may include an operation of determining whether a door is pushed using a change in a distance value sensed by the distance sensor 412 as the gasket 38 is compressed by movement of the second door 36.

According to an embodiment, the touch sensor 411 may be disposed at a lower portion of the first door 35 or a lower portion of the second door 36.

According to an embodiment, the at least one sensor device 410 may include a touch sensor 411. The instructions may include an operation of performing one of an operation of opening the first door 35 or an operation of opening the second door 36 based on a number of touches sensed using the touch sensor 411.

According to an embodiment, the instructions may perform an operation of opening the first door 35 in case of detecting one touch using the touch sensor 411, and may perform an operation of opening the second door 36 in case of detecting multiple touches using the touch sensor 411.

According to an embodiment, the touch sensor 411 may be disposed at a lower portion of the first door 35 or a lower portion of the second door 36.

According to an embodiment, the at least one sensor device 410 may include a distance sensor 412. The instructions may perform one of an operation of opening the first door 35 or an operation of opening the second door 36 based on a time during which a pushed state of a door measured using the distance sensor 412 is maintained.

According to an embodiment, the second door 36 may include a gasket 38 and the distance sensor 412 may be disposed outside the gasket 38 on the first door 35.

According to an embodiment, the instructions may determine whether a door is pushed using a change in a distance value sensed by the distance sensor 412 as the gasket 38 is compressed by movement of the second door 36, and based on a duration time of a pushed state of a door, perform an operation of opening the first door 35 in case of being pushed for a threshold time or less, and perform an operation of opening the second door 36 in case of being pushed exceeding the threshold time.

According to an embodiment, the door driving module 241 may include a first motor 2412 and a pusher 2414 disposed to receive power from the first motor 2412 and press the first door 35 or the second door 36.

According to an embodiment, the door driving module 241 may further include a second motor 2415 and a closing arm 2416 coupled to the first door 35 and configured to receive power from the second motor 2415 to close the first door 35.

According to an embodiment, the pusher 2414 may be disposed to press the second door 36. In case of performing the first open mode, the pusher 2414 may rotate the first door 35 and the second door 36 by pressing the second door 36 in a state in which the first door 35 and the second door 36 are engaged and, in case of performing the second open mode, the pusher 2414 may rotate the second door 36 by pressing the second door 36 in a state in which the first door 35 and the second door 36 are disengaged.

According to an embodiment, the refrigerator 1 may further include an open/close sensor disposed to sense whether a door is open.

According to an embodiment, the open/close sensor may include one of a magnetic sensor, a position sensor, or a reed switch.

According to an embodiment, the instructions may perform an operation of closing one door of the first door 35 or the second door 36 in case of detecting a specific motion using the at least one sensor device 410 in a state in which one door of the first door 35 or the second door 36 is open.

According to an embodiment, the instructions may perform an operation of closing one door of the first door 35 or the second door 36 in case that a time during which an open state of one door of the first door 35 or the second door 36 is maintained exceeds a set reference time.

In the disclosure, the above-described description has been made mainly of specific embodiments, but the disclosure is not limited to such specific embodiments, but should rather be appreciated as covering all various modifications, equivalents, and/or substitutes of various embodiments.

1. A refrigerator comprising:
a main body forming a storage space;
a first door including a door inner space, the first door being configured to open and close the storage space;
a second door configured to be rotatable relative to the first door to open and close the door inner space;
a door driving module configured to rotate at least one of the first door or the second door;
an electric latch configured to engage the first door and the second door;
at least one sensor device; and
at least one processor configured to:
control the at least one sensor device to sense a motion of a user, and
based on the sensed motion of the user in a state in which the first door and the second door are closed:
control an operation of opening the first door, or
control an operation of opening the second door.

2. The refrigerator of claim 1, wherein
the at least one processor is configured to:
while controlling the operation of opening the first door, controlling the door driving module to open the first door, and
while controlling the operation of opening the second door, controlling an electrical signal to be transferred to the electric latch to release the engagement between the first door and the second door.

3. The refrigerator of claim 1, wherein
the at least one sensor device includes:
a touch sensor, and
a distance sensor to detect a distance between the first door and the second door, and
the at least one processor is configured to:
control the operation of opening the first door in response to a touch being sensed by the touch sensor, and
control the operation of opening the second door in response to a door push being sensed by the distance sensor.

4. The refrigerator of claim 3, wherein
the second door includes a gasket, and
the distance sensor is disposed outside the gasket on the first door.

5. The refrigerator of claim 4, wherein
the at least one processor is configured to control a determination of a push of the second door according to a change in a distance value sensed by the distance sensor as the gasket is compressed by movement of the second door.

6. The refrigerator of claim 3, wherein
the touch sensor is disposed at a lower portion of the first door or a lower portion of the second door.

7. The refrigerator of claim 1, wherein
the at least one sensor device includes a touch sensor, and
the at least one processor is configured to control one of the operation of opening the first door or the operation of opening the second door based on a number of touches sensed using the touch sensor.

8. The refrigerator of claim 7, wherein
the at least one processor is configured to:
control the operation of opening the first door in response to one touch being sensed by the touch sensor, and
control the operation of opening the second door in response to multiple touches being sensed by the touch sensor.

9. The refrigerator of claim 7, wherein
the touch sensor is disposed at a lower portion of the first door or a lower portion of the second door.

10. The refrigerator of claim 1, wherein
the at least one sensor device includes a distance sensor to detect a distance between the first door and the second door, and
the at least one processor is configured to control one of the operation of opening the first door or the operation of opening the second door based on a time during which a pushed state of a door sensed by the distance sensor is maintained.

11. The refrigerator of claim 10, wherein
the second door includes a gasket, and
the distance sensor is disposed outside the gasket on the first door.

12. The refrigerator of claim 11, wherein
the at least one processor is configured to:
control a determination of a push of the first door or the second door according to a change in a distance value sensed by the distance sensor as the gasket is compressed, and
based on a duration time of a pushed state of the first door or the second door:
control the operation of opening the first door in response to the duration time being less than a threshold time, and
control the operation of opening the second door in response to the duration time being greater than the threshold time.

13. The refrigerator of claim 1, wherein
the door driving module includes:
a first motor, and
a pusher configured to receive power from the first motor and press the first door or the second door.

14. The refrigerator of claim 13, wherein
the door driving module includes:
a second motor, and
a closing arm coupled to the first door and configured to receive power from the second motor to close the first door.

15. The refrigerator of claim 13, wherein
the pusher is configured to press the second door,
during the operation of opening the first door, the pusher rotates the first door and the second door by pressing the second door in a state in which the first door is engaged with the second door, and
during the operation of opening the second door, the pusher rotates the second door by pressing the second door in a state in which the first door is disengaged with the second door.

16. The refrigerator of claim 1, further comprising:
an open/close sensor to sense whether a door is open.

17. The refrigerator of claim 16, wherein
the open/close sensor includes one of a magnetic sensor, a position sensor, or a reed switch.

18. The refrigerator of claim 1, wherein
in a state in which one of the first door or the second door is open, the at least one processor is configured to control a closing operation of the open one of the first door or the second door in response to the at least one sensor device sensing a predetermined motion of the user.

19. The refrigerator of claim 1, wherein
in response to one of the first door or the second door being open for more than a set reference time, the at least one processor is configured to control a closing operation of the one of the first door or the second door that is open.
